(19) United States
(12) Patent Application Publication
(10) Pub. No.: US 2018/0060842 A1
(43) Pub. Date: Mar. 1, 2018

(54) SYSTEMS AND METHODS FOR INITIATING ELECTRONIC FINANCIAL TRANSACTIONS AND INDICATING THAT THE ELECTRONIC TRANSACTIONS ARE POTENTIALLY UNAUTHORIZED

(71) Applicant: Lenovo (Singapore) Pte. Ltd., New Tech Park (SG)

(72) Inventors: Rod D. Waltermann, Rougemont, NC (US); Thomas L. McMasters, Apex, NC (US)

(21) Appl. No.: 15/252,515

(22) Filed: Aug. 31, 2016

(51) Int. Cl. G06Q 20/10; G06Q 20/40

(52) U.S. Cl. CPC G06Q 20/108; G06Q 20/4014; G06Q 20/4016

(57) ABSTRACT

In one aspect, a device includes a processor and storage accessible to the processor. The storage bears instructions executable by the processor to receive input pertaining to a bank account. The instructions are also executable to, based on the input, validly initiate an electronic financial transaction and indicate that the electronic financial transaction may be unauthorized.

### FIELD

The present application relates generally to initiating electronic financial transactions and indicating that the electronic financial transaction may be unauthorized.

### BACKGROUND

As recognized herein, there may be times when a person is forced, under threats of violence or harm, to access his or her bank account electronically in order to electronically transfer money to another account dictated by the assailant and will not be let go until the assailant sees that the transfer has been made. As also recognized herein, because the transfer is being performed remotely and electronically using a computer rather than in-person at one of the bank's brick-and-mortar branches, the bank may not know that the transaction is being performed under such conditions and hence may not know that it should take measures to prevent the transfer from being completed, even though the bank should still initiate the transfer so that the assailant sees that it is pending and lets the person go unharmed. There are currently no adequate solutions to the foregoing computer-related problem.

### SUMMARY

Accordingly, in one aspect a first device includes a processor and storage accessible to the processor. The storage bears instructions executable by the processor to receive input pertaining to a bank account. The instructions are also executable to, based on identification of the input, transmit a request to a second device to perform a financial transaction along with data indicating that the financial transaction is potentially unauthorized.

In another aspect, a method includes receiving input to perform a bank transfer, generating a request to perform the bank transfer and marking the request as being potentially unauthorized, and transmitting the request to a financial institution.

In still another aspect, a computer readable storage medium that is not a transitory signal includes instructions executable by a processor to receive input pertaining to a bank account. The instructions are also executable to, based on the input, validly initiate an electronic financial transaction and indicate that the electronic financial transaction may be unauthorized.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is an example block diagram of a network of devices in accordance with present principles;

FIGS. 3-5 are flow charts of example algorithms in accordance with present principles; and

FIGS. 6-12 are example user interfaces (UIs) in accordance with present principles.

### DETAILED DESCRIPTION

The present detailed description relates to validly initiating an electronic financial transaction and indicating to other financial institutions that the financial transaction may be unauthorized despite actually being initiated, such as if an owner of a bank account from which funds are being transferred is being forced in-person at his or her personal residence to make the transaction under threats of violence by a perpetrator. In this way, the perpetrator may believe that the financial transaction has been successfully performed by the owner while still at the owner's personal residence by viewing confirmation of the financial transaction at the owner's device and/or viewing the other account to which the funds are being transferred to see that the transfer is pending as would otherwise typically occur. Based on this belief, the perpetrator may then leave the personal residence thinking that the owner complied with the perpetrator's demands.

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

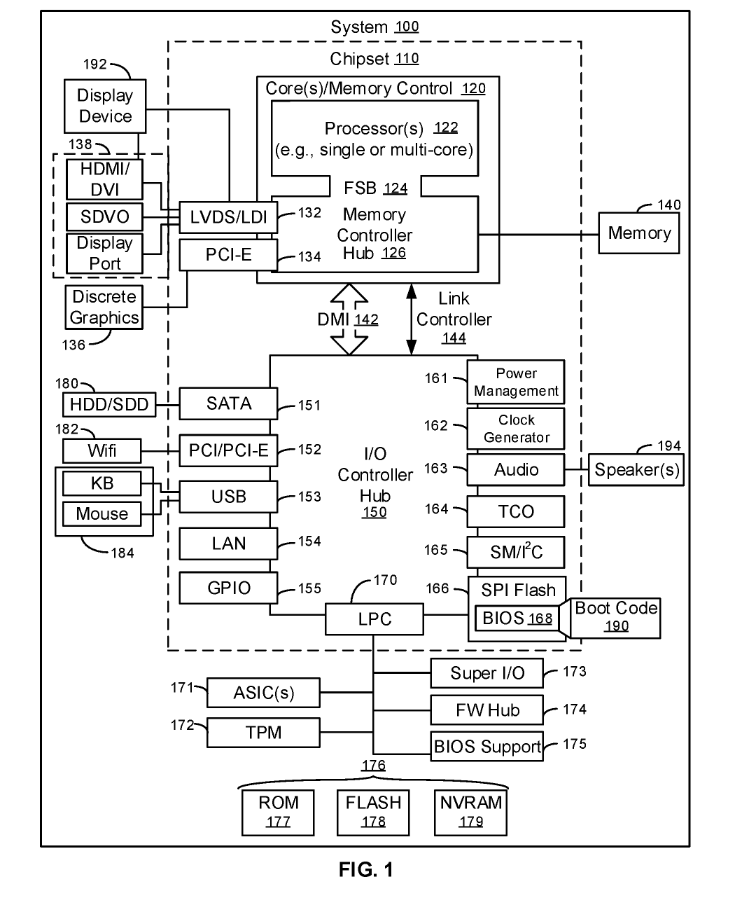

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for clarity, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 122, an audio receiver/microphone that provides input from the microphone to the processor 122 based on audio that is detected, such as via a user providing audible input to the microphone, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

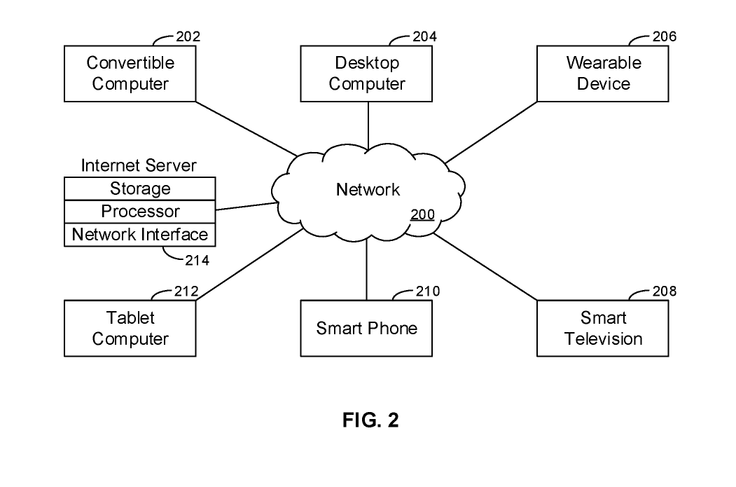

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

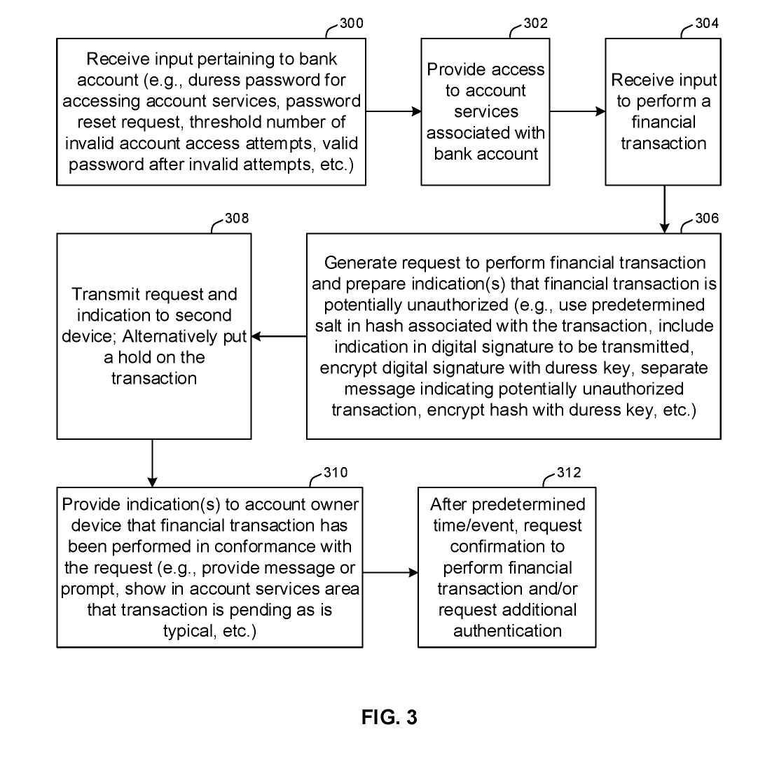

Referring to FIG. 3, it shows example logic that may be executed by a device such as the system 100 and that is associated with a first financial institution/bank at which an account owner has an account in accordance with present principles. Beginning at block 300, the logic may receive input from the account owner (via the owner's device) that pertains to the owner's account. For example, the input may be login input to access online account services at the user's device via a web browser. The login input may include a user name, and either of a default password or a duress password.

The default password may be used by the owner when logging in to the account services while not under duress or threats of violence, but instead to pay bills, transfer money voluntarily, or perform other voluntary actions. In contrast, the duress password may also be used for login with the same user name to gain access to the same online account services, but because the first financial institution may identify that the duress password has been used at block 300 the first financial institution may take additional measures as set forth further below. Note that the duress password need not be anything explicitly indicating duress such as “help”, but may instead be something that would not appear to the assailant as signaling a potentially unauthorized transaction is about to take place, such as the word “apple” or “California”.

Still in reference to block 300, note that still other types of input may be received thereat that may be identified by the first financial institution in order to take the additional measures as set forth below. For instance, a password reset request may be received and account access allowed responsive thereto, where the reset request may be identified as being potentially suspicious, particularly if received after a threshold number of failed login attempts. As another example, responsive to a threshold number of failed login attempts, account access may be granted, where the failed login attempts may be identified as being potentially suspicious. As but one more example, responsive to a correct password being received subsequent to a threshold number of failed login attempts, account access may be granted, where the failed login attempts may be identified as being potentially suspicious.

Responsive to receipt of the input at block 300, the logic may proceed to block 302 where the logic may provide access to the owner's account services. Thereafter the logic may proceed to block 304 where the logic may receive input from the owner to perform a financial transaction, potentially under duress, such as to transfer funds from the owner's financial institution to a second financial institution specified by the assailant.

Responsive to receipt of the input at block 304, the logic may proceed to block 306 where the logic may generate a request (e.g., via a transaction packet) to the second financial institution to perform or complete the transaction. Also at block 306, the logic may prepare one or more indications that the financial transaction is potentially unauthorized. For example, the request may be hashed, and one or both of a predetermined salt may then be applied to the hash and/or the hash may be encrypted with a private duress key associated with the first financial institution (instead of encrypted with a private default key otherwise used for voluntary, non-duress transactions). Additionally or alternatively, an indication that the transaction is potentially unauthorized may be included in a digital signature to accompany the request and/or the digital signature may be encrypted with the private duress key. Still further, the indication may be prepared in the form of a separate message to be sent to the second financial institution.

Responsive to generation of the request and indication(s) at block 306, the logic may then proceed to block 308. At block 308 the logic may transmit the generated request and indication(s) to a second device associated with the second financial institution, such as one specified by the assailant coercing the account owner to perform the transaction. Alternatively, at block 308 the logic may not transmit the request, but instead put a hold on the request at the first financial institution.

The logic may then move to block 310 where the logic (e.g., responsive to actually transmitting the request and indication(s)) may provide an indication to the account owner's device that the request has been successfully transmitted and/or that the financial transaction has been performed in conformance with the request. For example, a message or prompt may be presented on the display of the account owner's device indicating as much, and/or the account itself may reflect via the online access interface that the transaction is pending as would typically be shown for a valid transaction at that point.

After block 310 the logic may move to block 312. At block 312 the logic may request confirmation to perform the financial transaction, such as after a predetermined time from transmission of the request at block 308 or upon the occurrence of another event such as a subsequent logon to the owner's account services with the default password instead of the duress password. In addition to or in lieu of the foregoing but also at block 312, the logic may request additional authentication to ensure that the account owner is the one attempting to login to the account services, to ensure that the account owner is no longer under duress, and/or to ensure that the account owner intended to voluntarily perform the financial transaction.

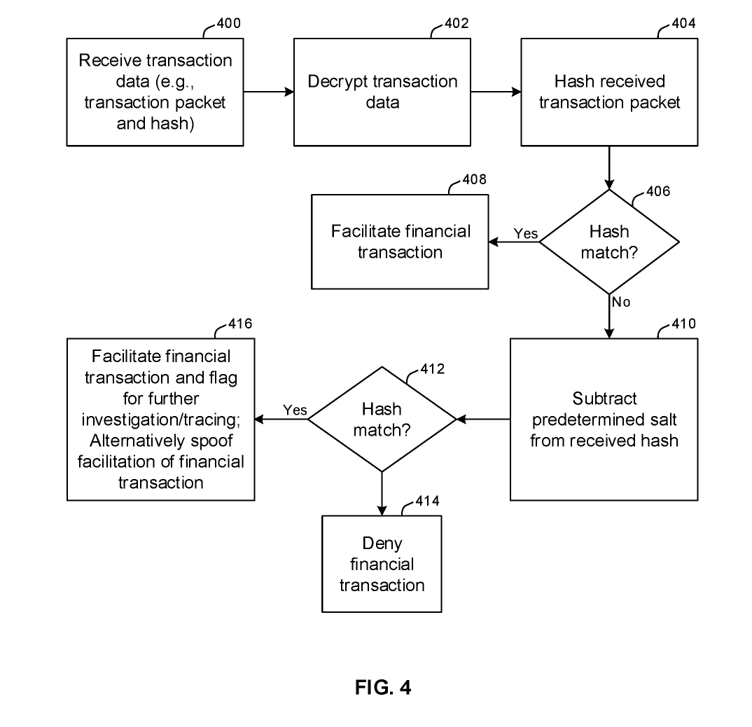

Now in reference to FIG. 4, it shows example logic that may be executed by a device such as the system 100 and that is associated with the second financial institution that is receiving the request for the financial transaction that was potentially made under duress in accordance with present principles. More specifically, the logic of FIG. 4 may be used for identifying a potentially unauthorized transaction when the request is received with a salted hash that may also be encrypted with a private duress key as disclosed herein.

Beginning at block 400, the logic may receive the transaction data/request from the first financial institution, such as a transaction packet with information for completing the financial transaction along with a salted, encrypted hash of the packet. Responsive to receipt of the transaction packet, the logic may move to block 402 where the logic may decrypt the transaction packet. The logic may do so using the private key for the second financial institution in embodiments where the packet was encrypted using the second financial institution's default public key. However, the logic may also do so using a second duress key that is reciprocal to a first duress key if the first duress key was used by the first financial institution to encrypt the packet. In some examples, the logic may attempt decryption using the private key first, and then responsive to that failing the logic may attempt decryption using the second duress key. If the attempt at decryption using the second duress key fails, the logic may then end.

Assuming that decryption does not fail, the logic may move to block 404 where the logic may hash the received transaction packet using the same process the first financial institution used to generate the hash referenced above at block 306. This process may have been previously agreed upon by the financial institutions.

From block 404 the logic may next move to decision diamond 406. At diamond 406 the logic may determine whether the hash it generated at block 404 matches the one received from the first financial institution and decrypted at block 402. Responsive to an affirmative determination, the logic may move to block 408 where the logic may facilitate and/or complete the financial transaction, which may be the case if the transaction was not initiated by the account owner under duress but instead he or she was voluntarily doing so.

However, responsive to a negative determination at diamond 406, the logic may instead move to block 410. A negative determination at diamond 406 may be the case if the hash received from the first financial institution at block 400 was salted as described herein, and/or if the transaction packet was altered in an unauthorized way during transmission. At block 410 the logic may at least attempt to subtract the predetermined salt from the received hash (e.g., using a process previously agreed-upon by the financial institutions) and then at diamond 412 compare this hash (minus the salt) to the one generated at block 404.

Responsive to a negative determination at diamond 412 the logic may proceed to block 414 where the logic may deny facilitating the financial transaction, which may occur if the transaction packet was altered in an unauthorized way during transmission and thus resulted in a mismatch of hashes. However, responsive to an affirmative determination at diamond 412 the logic may instead move to block 416 based on a hash match after subtracting the salt.

At block 416 the logic may facilitate and/or agree to complete the financial transaction and flag the financial transaction for further investigation and/or tracing by either or both financial institutions. Alternatively, the second financial institution may spoof that it is facilitating the financial transaction. In either case, if an assailant were to electronically access the account with the second financial institution to which the funds were sought to be transferred, the assailant would see and believe that the financial transaction is being performed as expected (e.g., even if in actuality it is not or will not be completed until further investigation is performed).

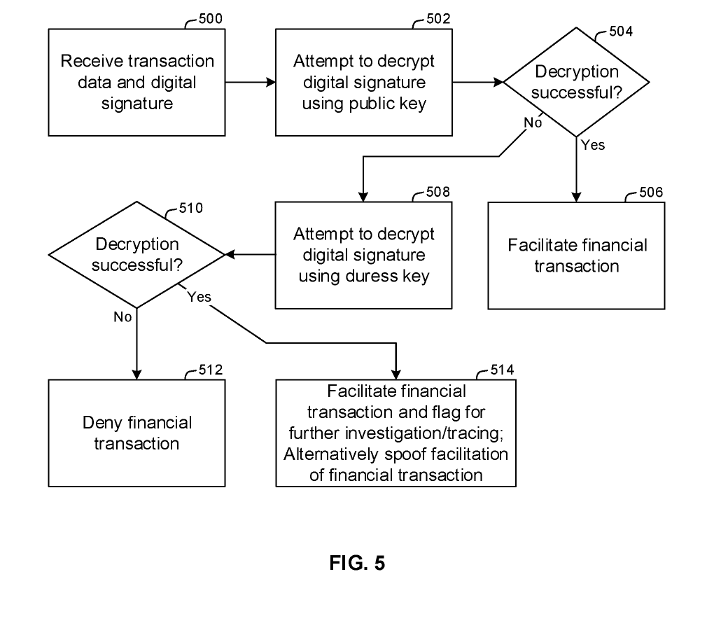

Before moving on to the description of FIG. 5, it is to be understood in reference to FIG. 4 that, in other embodiments, logic similar to that described above may be performed but rather than adding the salt to the hash, the first financial institution may add the salt to the transaction packet and keep the hash valid. The second financial institution may then subtract the salt from the transaction packet instead.

Now describing FIG. 5, it also shows example logic that may be executed by a device such as the system 100 and that is associated with the second financial institution that is receiving the request for the financial transaction that was potentially made under duress in accordance with present principles. The logic of FIG. 5 may be used for identifying a potentially unauthorized transaction when the request is received with a digital signature that is encrypted with a duress key in accordance with present principles. Additionally, note that in some embodiments the logic of FIG. 5 may be executed in conjunction with FIG. 4, while in others it may be executed by itself.

Beginning at block 500, the logic may receive the transaction data/request from the first financial institution, such as a transaction packet with information for completing the financial transaction along with a digital signature encrypted with a first duress key. The logic may then move to block 502 where the logic may at least attempt to decrypt the digital signature using the public key for the first financial institution.

Then at diamond 504 the logic may determine whether decryption has been successful. Responsive to an affirmative determination at diamond 504, which may be the case if the transaction is being made voluntarily and/or not under duress, the logic may move to block 506 and facilitate the financial transaction in due course. However, responsive to a negative determination at diamond 504, which may be the case if the digital signature was encrypted with the first duress key or if there was an error during decryption, the logic may move to block 508.

At block 508 the logic may attempt to decrypt the digital signature using a second duress key that is reciprocal to the first duress key and that is for decrypting data encrypted with the first duress key. The logic may then move to decision diamond 510 where the logic may determine whether decryption using the second duress key is successful. Responsive to a negative determination at diamond 510 (such as if there was an error during decryption and/or if the digital signature could not be verified), the logic may proceed to block 512 where the logic may deny facilitating the financial transaction.

However, responsive to an affirmative determination at diamond 510, the logic may proceed to block 514 where the logic may facilitate and/or agree to complete the financial transaction and flag the financial transaction for further investigation and/or tracing by either or both financial institutions. Alternatively, the second financial institution may spoof that it is facilitating the financial transaction. In either case, if an assailant were to electronically access the account with the second financial institution to which the funds were sought to be transferred, the assailant would see and believe that the financial transaction is being performed as expected (e.g., even if in actuality it is not or will not be completed until further investigation is performed).

Before moving on to the description of other figures, it is to be understood that logic similar to that set forth above may be performed based on other ways of indicating that a financial transaction is potentially unauthorized as disclosed herein. For example, if a hash of the transaction packet was encrypted with the first duress key (instead of the digital signature being encrypted with the first duress key), the hash may be decrypted using the second duress key to execute the steps described above in reference to block 514.

Additionally, note that the second financial institution may also, after receiving and decrypting the digital signature with the default public key or with the second duress key, identify an indication in the digital signature itself that the transaction is potentially unauthorized/made under duress and then execute the steps described above in reference to block 514. Separate messages indicating that the transaction is potentially unauthorized/made under duress may also be received and identified by the second financial institution and then it may execute the steps described above in reference to block 514.

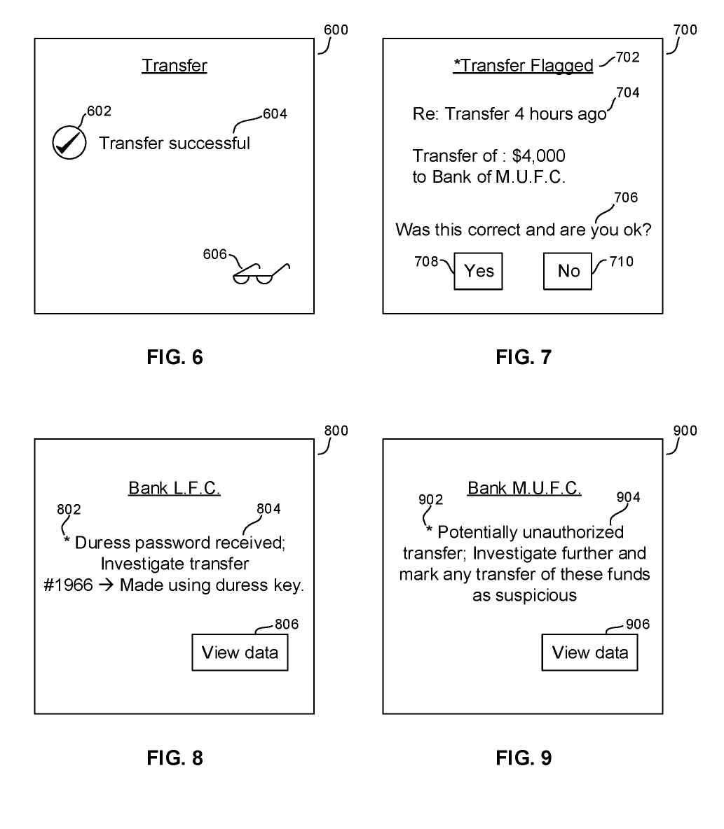

Now describing FIG. 6, it shows an example user interface (UI) 600 that may be generated by an account owner's financial institution when a financial transaction has been initiated under duress in accordance with present principles, with the UI 600 transmitted to the account owner's device for presentation on a display thereof. Note that the UI 600 includes a graphical indication 602 and text indication 604 that the transaction has been initiated successfully (e.g., even if it has been flagged as potentially unauthorized as disclosed herein). The UI 600 also includes a graphical indication 606 that may seem meaningless or not noteworthy to an assailant but that may convey to the account owner that the financial transaction has indeed been flagged as potentially made under duress. In this case, the example graphical indication 606 represents a pair of glasses, though other graphics may also be used such as a red star, a “thumbs up” graphic, etc.

FIG. 7 shows a UI 700 that may also be presented on the account owner's device after a threshold amount of time from when the potentially unauthorized transfer was made and/or upon a subsequent login to the owner's online account services, such as a login using the account owner's default password instead of the duress password. The UI 700 may include an indication 702 that the previous financial transaction has been identified as potentially unauthorized. Data 704 may also be presented regarding the transaction, such as the time at which it was made, the amount of the transaction, and the financial institution to which the funds were sought to be transferred.

The UI 700 may also include a prompt 706 asking whether the transaction was voluntarily intended to be made or not. A yes selector 708 may be selected to indicate that the transaction was voluntary, while a no selector may be selected to indicate that the transaction was indeed involuntarily made. Responsive to selection of the yes selector 708, an instruction may be transmitted to the account owner's financial institution to complete the transaction, to work with the second financial institution to continue the financial transaction since voluntary initiation has been confirmed, and/or to re-submit the transaction without an indication that it may be potentially unauthorized. Responsive to selection of the no selector 710, an instruction may be transmitted to the account owner's financial institution to cancel or reverse the transaction.

Continuing the detailed description in reference to FIG. 8, it shows a UI 800 that may be presented on a device of the account owner's financial institution so that an administrator at that financial institution can be made aware of a potentially unauthorized transaction. The UI 800 thus includes an indication 802 that a financial transaction has been identified by the financial institution's system as potentially unauthorized. Data 804 may also be presented regarding the transaction, such as an identity of the transaction (e.g., a transaction number), how the transaction was identified as potentially unauthorized (in this case, because it was generated using a duress key), and what was done to cause the associated indication to be generated (in this case, entrance of a duress password as the account owner's device). Also note that the UI 800 may include a selector 806 that is selectable to view additional data regarding the transaction, and/or to initiate/transmit a communication to the second financial institution to not complete the transfer (at all, until further investigation is conducted, etc.).

FIG. 9 shows a UI 900 that may be presented on a device of the second financial institution referenced above to which a transfer of funds is being attempted so that an administrator at the second financial institution can be made aware of a potentially unauthorized transaction. The UI 900 thus includes an indication 902 that a financial transaction has been identified by the second financial institution's system as potentially unauthorized, such as using the logic of FIG. 4 and/or FIG. 5. Data 904 may also be presented regarding the transaction, such as an identity of the transaction, how the transaction was identified as potentially unauthorized, that additional investigation should be undertaken, and that any transfer of the funds of the transaction to yet another financial institution should be marked or indicated as suspicious. Also note that the UI 900 may include a selector 906 that is selectable to view additional data regarding the transaction, and/or to cancel, delay processing, or put a hold on the transfer to the second financial institution.

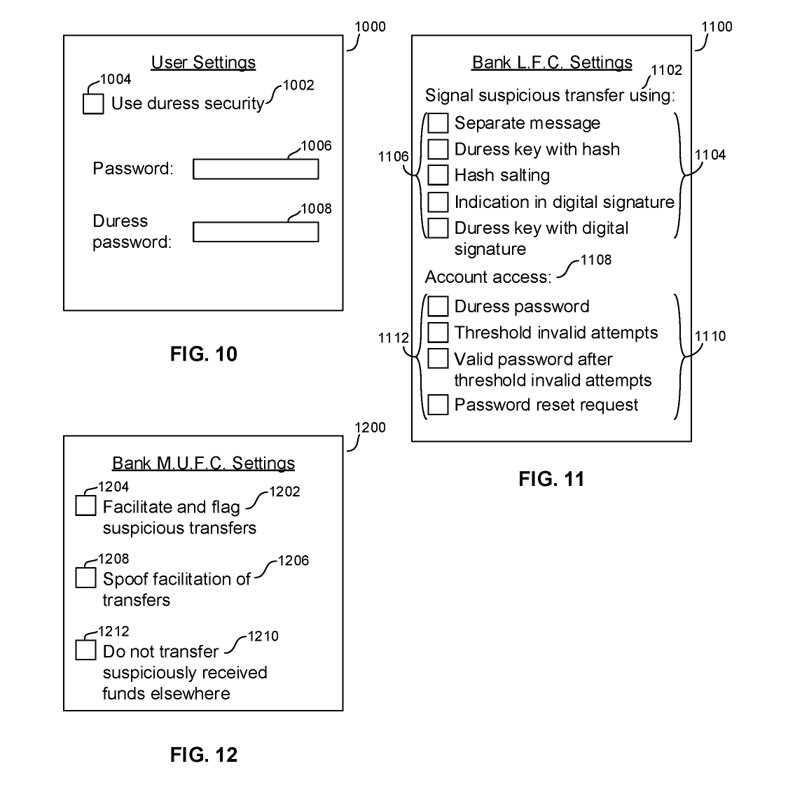

FIG. 10 shows an example UI 1000 for an account owner to configure settings for their device and/or online account services. The UI 1000 may be provided by the account owner's financial institution and presented on a display of the account owner's device.

The UI 1000 may include a first option 1002 (enableable using check box 1004) to enable transmission of data indicating that financial transactions are potentially unauthorized when one or more conditions are met as described herein. The UI 1000 may also include a first text entry field 1006 at which a default password may be entered and established for the account owner to use to login to the online account services to voluntarily perform financial transactions. The UI 1000 may further include a second text entry field 1008 at which a duress password may be entered and established for the account owner to use to login to the online account services when under duress in accordance with present principles.

Now describing FIG. 11, it shows an example UI 1100 that may be presented on a display of a device associated with the account owner's financial institution so that the financial institution can configure its own settings in accordance with present principles. The UI 1100 may include a first setting 1102 to configure one or more ways to indicate to other financial institutions that a financial transaction initiated by it is suspicious. Thus, example options 1104 may be presented that are respectively enableable using respective check boxes 1006 shown adjacent to each one. Example options 1104 may include using a separate message to the other financial institution, using a duress key to encrypt a hash as disclosed herein, salting a hash as disclosed herein, indicating that the transaction is potentially unauthorized in a digital signature as disclosed herein, and using a duress key to encrypt the digital signature as disclosed herein.

The UI 1100 may also include a second setting 1108 to configure one or more methods 1110 to provide duress access to an owner's account services, with each one being respectively enableable using respective check boxes 1112 shown adjacent to each one. Example methods 1110 may include allowing account access responsive to receipt of a duress password for login, allowing account access responsive to a threshold number of invalid login attempts, allowing account access responsive to receiving a valid default password after a threshold number of invalid login attempts, and allowing account access responsive to receiving a password reset request.

Now describing FIG. 12, it shows an example UI 1200 that may be presented on a display of a device associated with a second financial institution to which a bank transfer may be made under duress so that the second financial institution can configure its own settings in accordance with present principles. The UI 1200 may include a first option 1202 enableable using check box 1204 to facilitate and/or process a suspicious transaction but mark it as suspicious in accordance with present principles. The UI 1200 may also include a second option 1206 enableable using check box 1208 to spoof facilitation of a suspicious transaction without actually completing processing of the suspicious transaction. Still further, the UI 1200 may include a third option 1210 enableable using check box 1212 to configure the second financial institution's systems to not transfer funds received via a suspicious transaction to any other financial institution at least until the suspicious transaction can be investigated further and permission given by the second financial institution to complete such a transfer of funds to yet another financial institution.

Moving on from FIG. 12, it is to be understood in accordance with present principles that still other ways of marking or flagging a financial transaction may be used. For example, an indication or code may be inserted into a header of a communication to the second financial institution that concerns the suspicious financial transaction. An additional field or variable may also be transmitted in such a communication.

It is to also be understood in accordance with present principles that still other ways of identifying that a transaction is potentially suspicious may be used. For example, financial transaction marking as described herein may be performed based on the frequency of transactions, such as marking financial transactions as suspicious responsive to a threshold number of transactions occurring from an owner's account within a threshold amount of time. As another example, financial transaction marking may also be performed based on differing geography at which two transactions were initiated, such as if it would be impossible for one person to initiate transactions at different locations within a given time since it would require faster travel than is possible. As but another example, a financial transaction may be marked as suspicious if it is a transfer to a financial institution to which money has never been transferred from the user's account before, and then at a later time additional authentication may be requested of the account owner to confirm the transaction.

Still further, in some embodiment's biometric data from a wearable device sensing biometrics of the user (such as a smart watch) may be received and analyzed by a system undertaking present principles. The biometric data may be analyzed by the system to determine a mood of a user using mood recognition principles and algorithms. If the identified mood is one determined to be associated with potentially unauthorized transactions, such as may be determined from stored and/or learned data (e.g., learned by an artificial intelligence/inference module) correlating particular moods to potentially unauthorized transactions, then identification of such a mood as existing while the user concurrently performs a financial transaction (and/or is logged into their account services) may also be used to mark the financial transaction as potentially unauthorized in accordance with present principles. For example, identification of the user as being stressed while concurrently performing a financial transaction may be used to mark the financial transaction as potentially unauthorized, and other financial transactions may continue to be marked as potentially unauthorized for at least a threshold time thereafter.

Moreover, input from a sensor such as a camera or acoustic sensor (such as a microphone) may be used to determine whether to mark a financial transaction as potentially unauthorized. For example, if a system undertaking present principles receives camera input and executes object recognition on the camera input to identify a weapon (e.g., a firearm) as being present adjacent to the user and/or in the field of view of the camera, the identification of the weapon may be used to cause any ensuing financial transaction performed at the system while the weapon is present to be marked as potentially unauthorized.

As another example, if a system undertaking present principles receives acoustic sensor input and executes voice recognition on the acoustic sensor input, the system may identify and/or determine various words or phrases (such as ones that contain threats of violence or mentions of weapons) from the input as being indicative of a potentially unauthorized financial transaction, and accordingly any ensuing financial transaction performed using the system may be marked as potentially unauthorized while the voice of the particular person that spoke the words/phrases is still detected. Other background noises may also be analyzed based on input from an acoustic sensor, such as to identify the sound of a gun being loaded or cocked, and accordingly the system may mark a financial transaction as potentially unauthorized based on that. Echo location may also be used to determine whether another person is proximate to the user and a financial transaction may be marked as potentially unauthorized by the system based on that.

Also, note that in addition to or in lieu of marking financial transactions as potentially unauthorized while such things are detected, based on detection of such things financial transactions may be marked as potentially unauthorized by the system for at least a threshold amount of time (such as twenty four hours) from the detection.

It may now be appreciated that present principles provide for marking an electronic financial transaction when a person is threatened by an assailant and at least partially performing the financial transaction so that the assailant sees that the financial transaction has been conducted and leaves the threatened person unharmed. Other financial institutions may thus be made aware that the transaction is suspicious and to potentially delay or halt processing of the transaction. If implemented using a digital signature, for example, the marker may allow tracing to happen and every financial institution that forwards the transaction may also know to alter its own marker to thus propagate the financial transaction marking, thus providing a trail as the money moves around various accounts and/or financial institutions.

Additionally, notifications such as text message (e.g., SMS-based text messages), emails, etc. may be provided to financial administrators regarding such potentially unauthorized transactions, where those administrators may be people tasked with overseeing such transactions. The notifications may be provided to an administrator at the financial institution from which funds are to be transferred and/or to an administrator at the financial institution to which the funds are to be transferred.

Note that the “suspicious” marker may also be removed from an electronic transaction responsive to, for example, authenticating the user with an additional level of security (e.g., at a predetermined time from when the financial transaction was initiated) that may not otherwise be used during a normal and/or default authentication session. In this way it may be confirmed that a user intended to voluntarily make transaction that may otherwise seem suspicious, and thus allow the transaction to go through without continuing to be flagged and delayed based on “suspicious” activity.

Before concluding, it is to be understood that although a software application for undertaking present principles may be vended with a device sold to a financial institution for undertaking present principles, present principles may also apply in instances where such an application is downloaded from a server to the financial institution's device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A first device, comprising:
a processor; and
storage accessible to the processor and bearing instructions executable by the processor to:
receive input pertaining to a bank account; and
based on identification of the input, transmit, to a second device, a request to perform a financial transaction along with data indicating that the financial transaction is potentially unauthorized.

2. The first device of claim 1, wherein the instructions are executable by the processor to:
transmit, to a third device from which the input was received, an indication that the financial transaction has been performed in conformance with the request.

3. The first device of claim 1, wherein the input comprises login information to access a bank account service associated with the bank account, the login information being associated with potentially unauthorized transactions.

4. The first device of claim 3, wherein the instructions are executable by the processor to:
responsive to receipt of the login information, provide access to the bank account service, the access permitting generation of the request.

5. The first device of claim 1, wherein the input comprises a threshold number of invalid attempts to login to a banking account service associated with the bank account.

6. The first device of claim 5, wherein the instructions are executable by the processor to:
responsive to receipt of the threshold number of invalid attempts, provide access to the bank account service, the access permitting generation of the request.

7. The first device of claim 1, wherein the input comprises a valid password to login to a banking account service associated with the bank account, the valid password being received subsequent to a threshold number of login attempts using one or more invalid passwords.

8. The first device of claim 1, wherein the input comprises a request to reset a password associated with a banking account service, the banking account service associated with the bank account.

9. The first device of claim 1, wherein the data comprises a digital signature, the digital signature comprising an indication that the financial transaction is potentially unauthorized.

10. The first device of claim 1, wherein the data comprises a hash generated using a predetermined salt, the predetermined salt associated with a financial transaction being potentially unauthorized.

11. The first device of claim 1, wherein the data comprises a digital signature generated using a predetermined key, the predetermined key associated with potentially unauthorized financial transactions.

12. The first device of claim 1, wherein the data comprises a message indicating that the financial transaction is potentially unauthorized.

13. A method, comprising:
receiving input to perform a bank transfer;
generating a request to perform the bank transfer and marking the request as being potentially unauthorized; and
transmitting the request to a financial institution.

14. The method of claim 13, comprising:
providing an indication that the bank transfer has been performed.

15. The method of claim 13, wherein the request is marked as being potentially unauthorized based on receipt of a predetermined password.

16. The method of claim 13, comprising:
marking the request as being potentially unauthorized by transmitting the request along with a hash of the request, the hash of the request encrypted with a predetermined key for potentially unauthorized bank transfers.

17. The method of claim 13, comprising:
marking the request as being potentially unauthorized by transmitting the request with a digital signature that one or more of: comprises an indication that the bank transfer is potentially unauthorized, is generated using a predetermined key for potentially unauthorized bank transfers.

18. A computer readable storage medium that is not a transitory signal, the computer readable storage medium comprising instructions executable by a processor to:
receive input pertaining to a bank account; and
based on the input, validly initiate an electronic financial transaction and indicate that the electronic financial transaction may be unauthorized.

19. The computer readable storage medium of claim 18, wherein the input comprises a password associated with accessing the bank account under duress.

20. The computer readable storage medium of claim 18, wherein the instructions are executable by the processor to:
indicate, via one or more of a digital signature and a hash of the electronic financial transaction, that the electronic financial transaction may be unauthorized.
